(19) United States
(12) Patent Application Publication
(10) Pub. No.: US 2023/0095723 A1
(43) Pub. Date: Mar. 30, 2023

(54) TURBINE ENGINE WITH VARIABLE PITCH FAN

(71) Applicant: General Electric Company, Schenectady, NY (US)

(72) Inventor: Arthur William Sibbach, Boxford, MA (US)

(21) Appl. No.: 17/484,416

(22) Filed: Sep. 24, 2021

(51) Int. Cl. F02C 3/04; F02C 9/00; F02C 7/36

(52) U.S. Cl. CPC F02C 3/04; F02C 9/00; F02C 7/36; F05D 2220/32; F05D 2220/76

(57) ABSTRACT

A gas turbine engine includes a fan comprising fan blades. In a forward mode of operation the fan blades have a forward pitch and generate forward thrust, and in a reverse mode of operation the fan blades have a reverse pitch and generate reverse thrust. A fan drive shaft drives the fan and an electric machine is connected to the fan drive shaft. In a reverse mode of operation, the electric machine operates as a motor to convert stored electric energy into rotation of the fan drive shaft.

### FIELD

The present disclosure relates to a turbine engine with a variable pitch fan.

### BACKGROUND

A gas turbine engine generally includes a turbomachine and a rotor assembly. Gas turbine engines, such as turbofan engines, may be used for aircraft propulsion. Certain turbofan engines include a fan configured to generate forward thrust during a flight operation. During other operations, the fan may be configured to generate a reverse thrust to, e.g., slow down an aircraft incorporating the turbofan engine during a landing operation. Improvements to the fan of the turbofan engine to facilitate reverse thrust would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a schematic illustration of the gas turbine engine, in accordance with an exemplary aspect of the present disclosure.

FIG. 3 is an illustration of a method, in accordance with an exemplary aspect of the present disclosure.

FIG. 4 is a schematic illustration of a gas turbine engine, in accordance with an exemplary aspect of the present disclosure.

FIG. 5 is a schematic illustration of a gas turbine engine, in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the exemplary embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., —er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

The present disclosure is generally related to control of a turbine engine with a variable pitch fan blade. Typically, when a fan of the engine is placed in reverse pitch, the turbomachine drives the fan and the fan directs airflow away from the core of the turbomachine. Here, the core may be starved of air flow and exhaust gas reingestion may occur, both of which make it difficult for the turbomachine to drive the fan during a reverse thrust operation. For example, the turbomachine may stall.

The present disclosure includes control of a turbine engine to drive the fan with an electric machine during a reverse thrust operation. Driving the fan with the electric machine removes or reduces a contribution from the turbomachine (e.g., a low pressure shaft) to drive the fan. As the contribution of the turbomachine is reduced or removed, the speed or power output by the turbomachine may be reduced such that less air flow is required through the core to operate the turbomachine. Here, there is a reduced risk of the core being starved of air flow. In particular, the turbomachine may operate at or around idle or slower (e.g., may be shut down).

To facilitate a difference in speed between a low pressure shaft and a fan drive shaft, the turbomachine (e.g., a low pressure shaft) may be disconnected from a fan drive shaft or a gearbox may be used to account for a difference in speed. There may be a difference in speed, for example, if the turbomachine does not contribute to driving the fan.

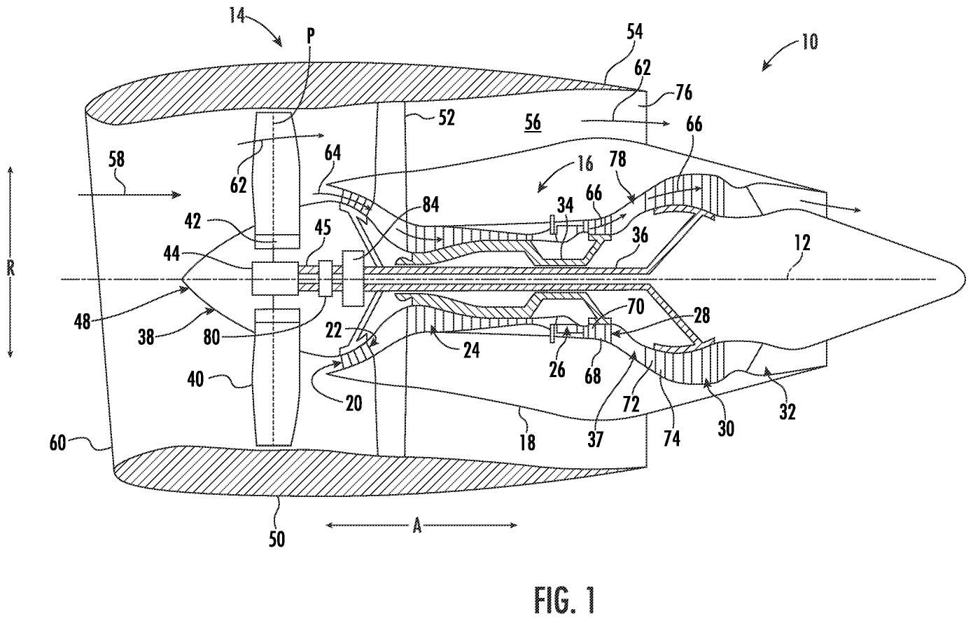

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine jet engine is an aeronautical, turbofan engine 10, configured to be mounted to an aircraft, such as in an under-wing configuration or tail-mounted configuration.

As shown in FIG. 1, the turbofan engine 10 defines an axial direction A (extending parallel to a longitudinal centerline axis 12 provided for reference), a radial direction R, and a circumferential direction (i.e., a direction extending about the axial direction A; not depicted).

In general, the turbofan engine 10 includes a fan section 14 and a turbomachine 16 disposed downstream from the fan section 14. The turbomachine 16 is sometimes also, or alternatively, referred to as a “core turbine engine”.

The exemplary turbomachine 16 includes an outer casing 18 that is substantially tubular and defines an annular inlet 20. The outer casing 18 encases, in serial flow relationship: a compressor section including a first, booster or low pressure (LP) compressor 22 and a second, high pressure (HP) compressor 24; a combustion section including a combustor 26; a turbine section including a first, high pressure (HP) turbine 28 and a second, low pressure (LP) turbine 30; and a jet exhaust nozzle section 32.

A high pressure (HP) shaft 34 or spool drivingly connects the HP turbine 28 to the HP compressor 24. A low pressure (LP) shaft 36 or spool drivingly connects the LP turbine 30 to the LP compressor 22. The compressor section, combustion section, turbine section, and jet exhaust nozzle section 32 are arranged in serial flow order and together define a core air flowpath 37 through the turbomachine 16.

The fan section 14 includes a variable pitch, single stage fan 38. The fan 38 includes a plurality of rotatable fan blades 40 coupled to a disk 42 in a spaced apart manner. As depicted, the fan blades 40 extend outwardly from disk 42 generally along the radial direction R.

The fan blades 40 are operatively coupled to one or more suitable actuation members 44. For example, the actuation members 44 may be configured to collectively or independently vary the pitch of the fan blades 40 with respect to pitch axis P. As described in further detail below, the fan blades 40 may have a forward pitch to produce a forward thrust or may have a reverse pitch to produce a reverse thrust.

A fan drive shaft 45 is operatively connected to and drives the fan 38. The fan blades 40, disk 42, and actuation member 44 are together rotatable about the longitudinal centerline axis 12 by the fan drive shaft 45. The fan section 14 is connected to the turbomachine 16 during a forward thrust operation. In particular, the fan drive shaft 45 is connected to the LP shaft 36.

The disk 42 is covered by a rotatable front nacelle 48 aerodynamically contoured to promote an airflow through the plurality of fan blades 40. Additionally, the exemplary fan section 14 includes an annular fan casing or outer nacelle 50 that at least partially, and for the embodiment depicted, circumferentially, surrounds the fan 38 and at least a portion of the turbomachine 16.

Moreover, for the embodiment depicted, the nacelle 50 is supported relative to the turbomachine 16 by a plurality of circumferentially-spaced outlet guide vanes 52. A downstream section 54 of the nacelle 50 extends over an outer portion of the turbomachine 16 so as to define a bypass airflow passage 56 therebetween.

During a forward thrust operation of the turbofan engine 10, a volume of air 58 enters the turbofan engine 10 through an associated inlet 60 of the nacelle 50 and/or fan section 14. As the volume of air 58 passes across fan blades 40, a first portion of the air 58 as indicated by arrows 62 is directed or routed into the bypass airflow passage 56 and a second portion of the air 58 as indicated by arrow 64 is directed or routed into the core air flowpath 37.

The pressure of the second portion of air 64 is increased as it is routed through the LP compressor 22 and the HP compressor 24 and into the combustor 26. More specifically, the compressor section, including the LP compressor 22 and HP compressor 24, defines an overall pressure ratio during operation of the turbofan engine 10 at a rated speed. The overall pressure ratio refers to a ratio of an exit pressure of the compressor section (i.e., a pressure of the second portion of air 64 at an aft end of the compressor section) to an inlet pressure of the compressor section (i.e., a pressure of the second portion of air 64 at the inlet 20 to the compressor section).

The compressed second portion of air 64 from the compressor section mixes with fuel and is burned within the combustion section to provide combustion gases 66. The combustion gases 66 are routed from the combustor 26, through the HP turbine 28 where a portion of thermal and/or kinetic energy from the combustion gases 66 is extracted via sequential stages of HP turbine stator vanes 68 that are coupled to the outer casing 18 and a plurality of HP turbine rotor blades 70 that are coupled to the HP shaft 34 or spool, thus causing the HP shaft 34 or spool to rotate, thereby supporting operation of the HP compressor 24.

The combustion gases 66 are then routed through the LP turbine 30 where a second portion of thermal and kinetic energy is extracted from the combustion gases 66 via sequential stages of LP turbine stator vanes 72 that are coupled to the outer casing 18 and a plurality of LP turbine rotor blades 74 that are coupled to the LP shaft 36 or spool, thus causing the LP shaft 36 or spool to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan engine 10, also providing propulsive thrust. The HP turbine 28, the LP turbine 30, and the jet exhaust nozzle section 32 at least partially define a hot gas path 78 for routing the combustion gases 66 through the turbomachine 16.

During operation of the turbofan engine 10, the fan 38 defines a fan pressure ratio. As used herein, the term “fan pressure ratio” refers to a ratio of an air pressure immediately downstream of the fan to an air pressure immediately upstream of the fan.

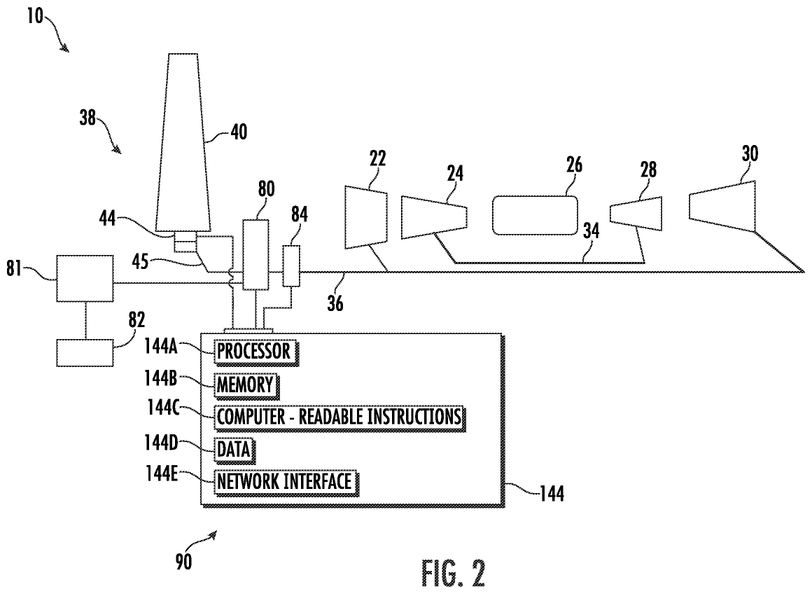

Referring now also to FIG. 2, providing a schematic illustration of the turbofan engine 10, the turbofan engine 10 further includes an electric machine 80 coupled to the fan drive shaft 45. The electric machine 80 is configured to operate as a generator to convert rotation of the fan drive shaft 45 to electric energy. The electric machine 80 is also configured to operate as a motor to convert electric energy into rotation of the fan drive shaft 45.

The electric machine 80 may generally include a stator and a rotor, the rotor rotatable relative to the stator. Additionally, the electric machine 80 may be configured in any suitable manner for converting mechanical power to electrical power and electrical power to mechanical power. For example, the electric machine may be configured as an asynchronous or induction electric machine operable to generate or utilize alternating current (AC) electric power. Alternatively, the electric machine may be configured as a synchronous electric machine operable to generate or utilize AC electric power or direct current (DC) electric power. In such a manner it will be appreciated that the stator, the rotor, or both may generally include one or more of a plurality of coils or winding arranged in any suitable number of phases, one or more permanent magnets, one or more electromagnets, etc. Other exemplary electric machines 80 may be used as well.

Moreover, it will be appreciated that for the exemplary embodiment depicted, the electric machine 80 is generally configured coaxially with the centerline axis 12 of the turbofan engine 10, which for the embodiment depicted means the electric machine 80 is also configured coaxially with the fan drive shaft 45 and the LP shaft 36. With such a configuration, the electric machine 80 may be referred to as an “embedded” electric machine. In other embodiments, however, the electric machine 80 may not be coaxial with the centerline axis 12 of the turbofan engine 10, and instead may be offset and connected through, e.g., a suitable geartrain.

Referring momentarily to FIG. 2, an energy storage device 82 is configured to store electric energy generated by the electric machine 80. The energy storage device 82 provides stored electric energy to the electric machine 80 when it operates as a motor. A power conditioning and distribution device 81 may connect the electric machine 80 to the energy storage device 82. The power conditioning and distribution device 81 may include power electronics or similar structure for, e.g., converting electric power between AC and DC electric power.

It will be appreciated, however, that in other exemplary embodiments, the electric machine 80 may additionally or alternatively be in electrical communication with any other suitable power source and/or power storage assembly.

Referring again to FIGS. 1-2, the LP shaft 36 is connected to the fan drive shaft 45 by a clutch 84 that is configured to selectively connect the LP shaft 36 (e.g., the turbomachine) to the fan drive shaft 45. The electric machine 80 and the LP shaft 36 are on opposite sides of the clutch 84. As such, the clutch 84 is configured to disconnect the fan drive shaft 45 from the LP shaft 36 while the electric machine 80 remains connected to the fan drive shaft 45. Alternatively, the clutch 84 connects the LP shaft 36 to the fan drive shaft 45 and both the LP shaft 36 and the electric machine 80 are connected to the fan drive shaft 45. This configuration enables multiple modes of operation as described in further detail below. As will be appreciated, when the clutch 84 disconnects the fan drive shaft 45 from the LP shaft 36, the fan drive shaft 45 may rotate independently of the LP shaft 36. By contrast, when the clutch 84 connects the fan drive shaft 45 with the LP shaft 36, the fan drive shaft 45 and LP shaft 36 are rotatably fixed to one another such that the fan drive shaft 45 and LP shaft 36 rotate at the same speed or otherwise at related speeds, for example, if a speed reduction gearbox connects the LP shaft 36 to the fan drive shaft 45.

In alternative embodiments, the fan drive shaft 45 is fixedly connected to the LP shaft 36. For example, the clutch 84 may be omitted. In such embodiments, the fan drive shaft 45 may be connected to the LP shaft 36 by a gearbox as described in further detail.

Referring to FIG. 2, a controller 90 may control the actuation members 44 to control the pitch of the fan blades 40 to have a forward pitch and generate a forward thrust or to have a reverse pitch and generate a reverse thrust.

The controller 90 may control the electric machine 80 to operate as a generator that is driven by the fan drive shaft 45 and charges the energy storage device 82. The controller 90 may control the electric machine 80 to operate as a motor that is powered by the energy storage device 82 and drives the fan drive shaft 45.

In addition, the controller 90 may control the clutch 84 to connect the LP shaft 36 to the fan drive shaft 45 or to disconnect the LP shaft 36 from the fan drive shaft 45.

In general, the exemplary controller 90 depicted in FIG. 2 is configured to receive the data sensed from the one or more sensors or commands (e.g., a mode command) received from one or more systems and, e.g., make control decisions based on the received data.

In one or more exemplary embodiments, the controller 90 depicted in FIG. 2 may be a stand-alone controller, or alternatively, may be integrated into one or more of a controller for the turbofan engine 10, a controller for an aircraft including the turbofan engine 10, etc.

Referring particularly to the operation of the controller 90, in at least certain embodiments, the controller 90 can include one or more computing device(s) 144. The computing device(s) 144 can include one or more processor(s) 144A and one or more memory device(s) 144B. The one or more processor(s) 144A can include any suitable processing device, such as a microprocessor, microcontroller, integrated circuit, logic device, and/or other suitable processing device. The one or more memory device(s) 144B can include one or more computer-readable media, including, but not limited to, non-transitory computer-readable media, RAM, ROM, hard drives, flash drives, and/or other memory devices.

The one or more memory device(s) 144B can store information accessible by the one or more processor(s) 144A, including computer-readable instructions 144C that can be executed by the one or more processor(s) 144A. The instructions 144C can be any set of instructions that when executed by the one or more processor(s) 144A, cause the one or more processor(s) 144A to perform operations. In some embodiments, the instructions 144C can be executed by the one or more processor(s) 144A to cause the one or more processor(s) 144A to perform operations, such as any of the operations and functions for which the controller 90 and/or the computing device(s) 144 are configured, the operations for operating the turbofan engine 10 (e.g, method 300), as described herein, and/or any other operations or functions of the one or more computing device(s) 144.

The instructions 144C can be software written in any suitable programming language or can be implemented in hardware. Additionally, and/or alternatively, the instructions 144C can be executed in logically and/or virtually separate threads on processor(s) 144A.

The one or more memory device(s) 144B can further store data 144D that can be accessed by the processor(s) 144A. For example, the data 144D can include data indicative of power flows, data indicative of engine/aircraft operating conditions, and/or any other data and/or information described herein.

The computing device(s) 144 can also include a network interface 144E used to communicate, for example, with the other components of the turbofan engine 10, the aircraft incorporating the gas turbine engine, etc. For example, in the embodiment depicted, the turbofan engine 10 may operate in a number of modes of operation. The controller 90 is operably coupled to the one or more aircraft systems (e.g., a flight management system or other aircraft control system) through, e.g., the network interface, such that the controller 90 may receive data or commands indicative of various modes.

The network interface 144E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

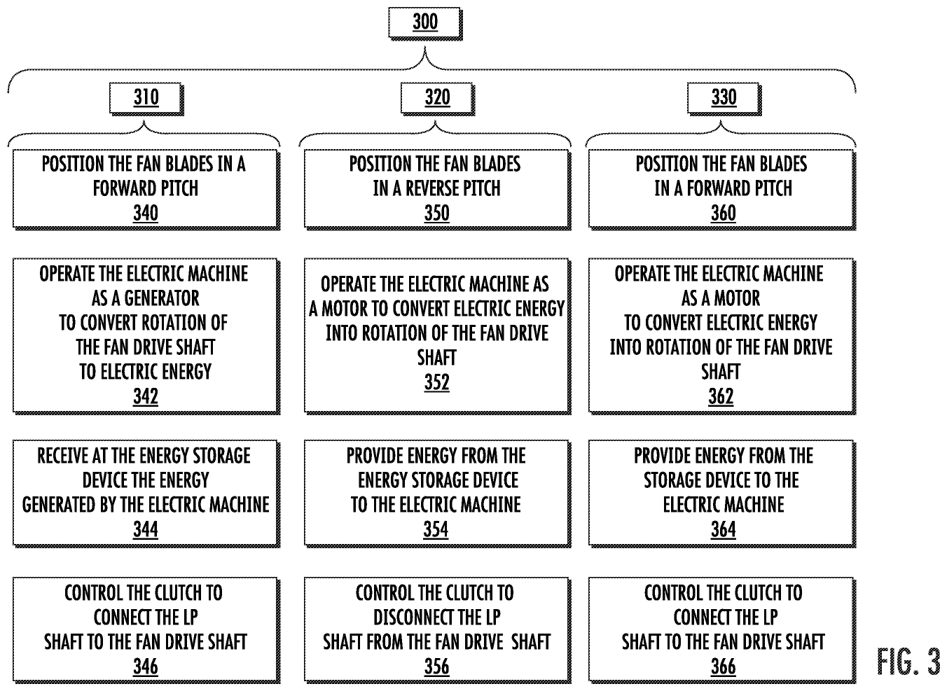

Referring to FIG. 3, the controller 90 may control the pitch of the fan blades 40, the mode of operation of the electric machine 80, and the clutch 84 according to a method 300. The method 300 includes a first forward mode of operation 310, a reverse mode of operation 320, and a second forward mode of operation 330. The first forward mode of operation 310 may be any flight operation, including takeoff, climb, cruise, dissent, etc. The reverse mode of operation 320 may be a reverse thrust operation initiated as, or shortly after, an aircraft incorporating the turbofan engine 10 lands to slow down the aircraft and shorten a slow-down time for the aircraft. The second forward mode of operation 330 may be a taxi operation after the aircraft incorporating the turbofan engine 10 lands and after the reverse mode of operation 320.

According to a first step 340 of the first forward mode of operation 310, the controller 90 controls the actuation members 44 to position the fan blades 40 in a forward pitch to generate a forward thrust. According to a second step 342 of the first forward mode of operation 310, the controller 90 controls the electric machine 80 to operate as a generator to convert rotation of the fan drive shaft 45 to electric energy. Controlling the electric machine 80 to operate as a generator to convert rotation of the fan drive shaft 45 to electric energy at second step 342 an amount of energy that is commensurate with the size and requirements of the aircraft and/or propulsion engine. According to a third step 344, the energy storage device 82 receives and stores the electric energy generated by the electric machine 80 (e.g., stored energy). According to a fourth step 346 of the first forward mode of operation 310, the controller 90 controls the clutch 84 to connect the LP shaft 36 to the fan drive shaft 45. Controlling the clutch 84 to connect the LP shaft 36 at 346 may include maintaining the LP shaft 36 connected to the fan drive shaft 45.

In the first forward mode of operation 310, the LP shaft 36 drives the fan drive shaft 45 such that the fan 38 provides a forward thrust and the fan drive shaft 45 drives the electric machine 80 to generate energy that is stored at the energy storage device 82.

According to a first step 350 of the reverse mode of operation 320, the controller 90 controls the actuation members 44 to position the fan blades 40 in a reverse pitch to generate a reverse thrust. According to a second step 352 of the reverse mode of operation 320, the controller 90 controls the electric machine 80 to operate as a motor to convert electric energy into rotation of the fan drive shaft 45.

According to a third step 354, the energy storage device 82 provides energy to the electric machine 80 to drive the motor. The size of the electric machine 80 may be selected to be commensurate with the size and requirements of the aircraft and/or propulsion engine. For example, providing energy to the electric machine 80 may include providing at least about 50 kW megawatts (MW) of electric power (e.g., for a business jet or small commuter aircraft), and up to about 10 MW of electric power (e.g., for a widebody aircraft). According to a fourth step 356 of the reverse mode of operation 320, the controller 90 controls the clutch 84 to disconnect the LP shaft 36 from the fan drive shaft 45.

In the reverse mode of operation 320, as the LP shaft 36 is disconnected, the turbomachine 16 may operate at or around idle or slower (e.g., may be shut down) to avoid starving the core of airflow and prevent exhaust gas reingestion. The electric machine 80 drives the fan drive shaft 45 such that the fan 38 provides a reverse thrust. The electric machine 80 is powered by electric energy, e.g., from the energy storage device 82.

It will be appreciated, that as used herein, the term “idle” refers to an operating condition corresponding to the lowest rotational speed whereby the turbofan engine 10 may continue operating with power added only through combustion of fuel within the combustion section. The term “around idle” mean a rotational speed corresponding to the idle operating condition plus 15%. Operating around idle may facilitate extracting some power from the turbomachine 16 to drive various accessory systems.

According to a first step 360 of the second forward mode of operation 330, the controller 90 controls the actuation members 44 to position the fan blades 40 in a forward pitch to generate a forward thrust. According to a second step 362 of the second forward mode of operation 330, the controller 90 controls or operates the electric machine 80 as a motor to convert electric energy into rotation of the fan drive shaft 45. According to a third step 364, the energy storage device 82 provides energy to the electric machine 80 to drive the motor. According to a fourth step 366 of the second forward mode of operation 330, the controller 90 controls the clutch 84 to connect the LP shaft 36 to the fan drive shaft 45.

In the second forward mode of operation 330, the fan 38 provides a forward thrust and the electric machine 80 drives the fan drive shaft 45. The controller 90 may further control the clutch 84 such that the LP shaft 36 is connected to the fan drive shaft 45. Here, the electric machine 80 and the LP shaft 36 together drive the fan drive shaft 45.

It will be appreciated, however, that in other exemplary aspects, the electric energy generated by the electric machine 80 in the first forward mode of operation 310 may additionally or alternatively be provided to any other suitable power sink, such as to an aircraft incorporating the turbofan engine 10, to an electric machine operable with a different propulsion device (e.g., a separate turbofan engine, an electric fan, etc.), or to a remote energy storage assembly. Similarly, it will be appreciated that in other exemplary aspects, the electric power provided to the electric machine 80 during the reverse mode of operation 320, the second forward mode of operation 330, or both, may be provided from any suitable power source, such as a remote energy storage assembly, an electric machine operable with a different engine (e.g., an electric machine driven by a separate turbofan engine, an auxiliary power unit, etc.).

In the methods described above, the controller moves the fan blades between the forward pitch and the reverse pitch in conjunction with the forward mode of operation and the reverse mode of operation. In addition, The fan 38 rotates in a first rotational direction in both the forward mode of operation and the reverse mode of operation.

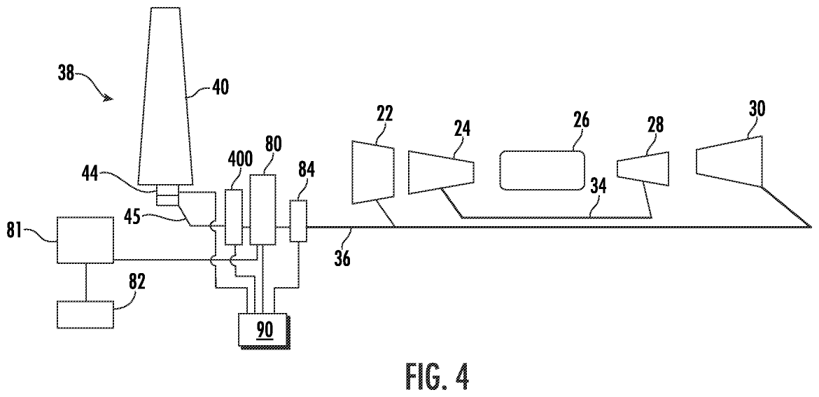

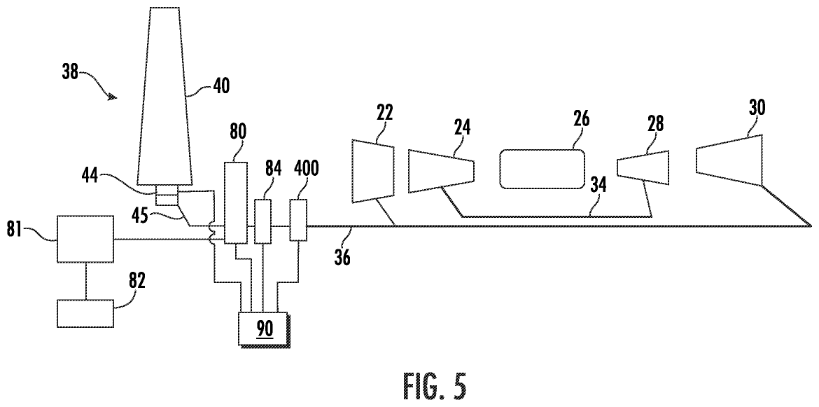

Referring to FIGS. 4-5, a speed reduction device 400 (e.g., a power gear box) may connect the fan drive shaft 45 to the LP shaft 36. The speed reduction device 400 includes a plurality of gears for stepping down the rotational speed of the LP shaft 36 to a more efficient rotational fan speed. Accordingly, for the embodiments depicted, the turbomachine 16 (shown in FIG. 1) is operably coupled to the fan 38 through the speed reduction device 400.

Referring to FIG. 4, the speed reduction device 400 may connect the LP shaft 36 and the electric machine 80 to the fan 38. For example, the speed reduction device 400 may disassociate the speed of the fan 38 from the speed of the LP turbine 30 and from the speed of the electric machine 80.

Referring to FIG. 5, the speed reduction device 400 may connect the LP shaft 36 to the fan 38. For example, the speed reduction device 400 may disassociate the speed of the fan 38 from the speed of the LP turbine 30. Here, the speed of the LP shaft 36 is reduced before it reaches the electric machine 80.

The speed reduction device 400 may be controlled by the controller 90 to disassociate the speed of the fan 38 with respect to the speed of the LP turbine 30.

It should be appreciated that the exemplary turbofan engine 10 depicted in FIG. 1 is by way of example only, and that in other exemplary embodiments, the turbofan engine 10 may have any other suitable configuration. For example, aspects of the present disclosure may be utilized with any other suitable aeronautical gas turbine engine, such as a turboshaft engine, turboprop engine, turbojet engine, etc. Further, aspects of the present disclosure may further be utilized with any aeroderivative gas turbine engine, such as a nautical gas turbine engine.

Other gas turbine engines to which the present disclosure may be applied may have alternative configurations. By way of example such engines may have an alternative number of interconnecting shafts (e.g., two) and/or an alternative number of compressors and/or turbines. Further the engine may not include a gearbox provided in the drive train from a turbine to a compressor and/or fan, may be configured as an unducted gas turbine engine (e.g., excluding the outer nacelle 50), etc.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine, comprising: a turbomachine having a compressor, a combustor, and a turbine in serial flow order; a fan comprising fan blades, wherein in a forward mode of operation the fan blades have a forward pitch and generate forward thrust, and in a reverse mode of operation the fan blades have a reverse pitch and generate reverse thrust; a controller that is configured to move the fan blades between the forward pitch and the reverse pitch in conjunction with the forward mode of operation and the reverse mode of operation; a fan drive shaft configured to drive the fan, wherein the turbomachine is configured to drive the fan drive shaft; an electric machine connected to the fan drive shaft, wherein the electric machine is configured to, in the reverse mode of operation, operate as a motor to convert electric energy into rotation of the fan drive shaft; and wherein the controller is operably connected to the electric machine, wherein the controller is further configured to control the electric machine to operate as the motor in the reverse mode of operation.

The gas turbine engine of one or more of these clauses, wherein the electric machine is configured to, in the forward mode of operation, operate as a generator to convert rotation of the fan drive shaft to electric energy, wherein the controller is configured to control the electric machine to operate as the generator in the forward mode of operation.

The gas turbine engine of one or more of these clauses, comprising an energy storage device configured to: receive electric energy from the electric machine in the forward mode of operation; and transmit electric energy to the electric machine in the reverse mode of operation.

The gas turbine engine of one or more of these clauses, wherein the turbomachine comprises a turbomachine shaft, and wherein the gas turbine engine comprises a clutch that is configured to selectively connect the turbomachine shaft to the fan drive shaft.

The gas turbine engine of one or more of these clauses, wherein the controller is operatively connected to the clutch, wherein the controller is further configured to control the clutch to disconnect, in the reverse mode of operation, the turbomachine from the fan drive shaft.

The gas turbine engine of one or more of these clauses, wherein the controller is further configured to control the clutch to connect, in the forward mode of operation, the turbomachine to the fan drive shaft.

The gas turbine engine of one or more of these clauses, further comprising a speed reduction device, wherein the turbomachine comprises a turbomachine shaft that is configured to drive the fan drive shaft, and wherein the speed reduction device is configured to reduce a speed of the turbomachine shaft relative to the fan drive shaft.

The gas turbine engine of one or more of these clauses, wherein the speed reduction device is between the fan and the electric machine.

The gas turbine engine of one or more of these clauses, wherein the speed reduction device is between an LP turbine and the electric machine.

The gas turbine engine of one or more of these clauses, comprising a clutch between the electric machine and an LP turbine.

The gas turbine engine of one or more of these clauses, wherein the fan rotates in a first rotational direction in the forward mode of operation and the reverse mode of operation.

The gas turbine engine of one or more of these clauses, wherein the turbomachine operates no faster than idle in the reverse mode of operation.

The gas turbine engine of one or more of these clauses, wherein the electric machine is further configured to in the forward mode of operation, convert stored energy into rotation of the fan drive shaft.

A method of operating a gas turbine engine having a turbomachine selectively or fixedly coupled to a fan, the method comprising: operating the gas turbine engine in a forward mode of operation, wherein operating the gas turbine engine in the forward mode of operation comprises positioning a plurality of fan blades of the fan in a forward pitch to generate a forward thrust; and operating the gas turbine engine in a reverse mode of operation, wherein operating the gas turbine engine in the reverse mode of operation comprises: positioning the plurality of fan blades of the fan in a reverse pitch to generate a reverse thrust; and operating an electric machine as a motor to convert electric energy into rotation of a fan drive shaft.

The method of one or more of these clauses, wherein operating the gas turbine engine in the forward mode of operation comprises operating the electric machine as a generator to convert rotation of a fan drive shaft coupled to the plurality of fan blades to electric energy.

The method of one or more of these clauses, further comprising: receiving, at an energy storage device connected to the electric machine, power from the electric machine in the forward mode of operation; and transmitting, from the energy storage device, energy to the electric machine in the reverse mode of operation.

The method of one or more of these clauses, comprising: operating a clutch, wherein the clutch is configured to selectively connect a turbomachine shaft of the turbomachine to the fan drive shaft, wherein operating the clutch comprises: operating the clutch in the forward mode of operation to connect the turbomachine shaft to the fan drive shaft; and operating the clutch in the reverse mode of operation to disconnect the turbomachine shaft from the fan drive shaft.

The method of one or more of these clauses, comprising operating the turbomachine at no faster than idle in the reverse mode of operation.

The method of one or more of these clauses, wherein operating the gas turbine engine in the forward mode of operation comprises operating the electric machine as a motor to convert electric energy into rotation of the fan drive shaft.

The method of one or more of these clauses, comprising reducing a speed of the fan drive shaft relative to a turbomachine shaft of the turbomachine.

1. A gas turbine engine, comprising:
a turbomachine having a compressor, a combustor, and a turbine in serial flow order;
a fan comprising fan blades, wherein in a forward mode of operation the fan blades have a forward pitch and generate forward thrust, and in a reverse mode of operation the fan blades have a reverse pitch and generate reverse thrust;
a fan drive shaft configured to drive the fan, wherein the turbomachine is configured to drive the fan drive shaft;
wherein the turbomachine comprises a turbomachine shaft, and wherein the gas turbine engine comprises a clutch that is configured to selectively connect the turbomachine shaft to the fan drive shaft;
an electric machine connected to the fan drive shaft, wherein the electric machine is configured to, in the reverse mode of operation, operate as a motor to convert electric energy into rotation of the fan drive shaft; and
a controller that is configured to:
move the fan blades between the forward pitch and the reverse pitch in conjunction with the forward mode of operation and the reverse mode of operation;
control the clutch to disconnect, in the reverse mode of operation, the turbomachine from the fan drive shaft and
control the electric machine to operate as the motor in the reverse mode of operation.

2. The gas turbine engine of claim 1, wherein the electric machine is configured to, in the forward mode of operation, operate as a generator to convert rotation of the fan drive shaft to electric energy, wherein the controller is configured to control the electric machine to operate as the generator in the forward mode of operation.

3. The gas turbine engine of claim 2, comprising an energy storage device configured to:
receive electric energy from the electric machine in the forward mode of operation; and
transmit electric energy to the electric machine in the reverse mode of operation.

4. (canceled)

5. (canceled)

6. The gas turbine engine of claim 1, wherein the controller is further configured to control the clutch to connect, in the forward mode of operation, the turbomachine to the fan drive shaft.

7. The gas turbine engine of claim 1, further comprising a speed reduction device, wherein the turbomachine comprises a turbomachine shaft that is configured to drive the fan drive shaft, and wherein the speed reduction device is configured to reduce a speed of the turbomachine shaft relative to the fan drive shaft.

8. The gas turbine engine of claim 7, wherein the speed reduction device is between the fan and the electric machine.

9. The gas turbine engine of claim 7, wherein the speed reduction device is between an LP turbine and the electric machine.

10. The gas turbine engine of claim 7, comprising the clutch between the electric machine and an LP turbine.

11. The gas turbine engine of claim 1, wherein the fan rotates in a first rotational direction in the forward mode of operation and the reverse mode of operation.

12. The gas turbine engine of claim 1, wherein the turbomachine operates at a speed that is greater than zero and no faster than idle in the reverse mode of operation.

13. The gas turbine engine of claim 1, wherein the electric machine is further configured to, in the forward mode of operation, convert stored energy into rotation of the fan drive shaft.

14. A method of operating a gas turbine engine having a turbomachine selectively or fixedly coupled to a fan, the method comprising:
operating the gas turbine engine in a forward mode of operation, wherein operating the gas turbine engine in the forward mode of operation comprises positioning a plurality of fan blades of the fan in a forward pitch to generate a forward thrust; and
operating the gas turbine engine in a reverse mode of operation, wherein operating the gas turbine engine in the reverse mode of operation comprises:
positioning the plurality of fan blades of the fan in a reverse pitch to generate a reverse thrust; and
operating a clutch to disconnect a turbomachine shaft from a fan drive shaft, wherein the clutch is configured to selectively connect a turbomachine shaft of the turbomachine to the fan drive shaft;
operating an electric machine as a motor to convert electric energy into rotation of the fan drive shaft.

15. The method of claim 14, wherein operating the gas turbine engine in the forward mode of operation comprises operating the electric machine as a generator to convert rotation of a fan drive shaft coupled to the fan to electric energy.

16. The method of claim 15, further comprising:
receiving, at an energy storage device connected to the electric machine, power from the electric machine in the forward mode of operation; and
transmitting, from the energy storage device, energy to the electric machine in the reverse mode of operation.

17. The method of claim 14, further comprising:
operating the clutch in the forward mode of operation to connect the turbomachine shaft to the fan drive shaft; and

18. The method of claim 17, comprising operating the turbomachine at a speed that is greater than zero and no faster than idle in the reverse mode of operation.

19. The method of claim 17, wherein operating the gas turbine engine in the forward mode of operation comprises operating the electric machine as a motor to convert electric energy into rotation of the fan drive shaft.

20. The method of claim 14, comprising reducing a speed of the fan drive shaft relative to a turbomachine shaft of the turbomachine.

21. A gas turbine engine, comprising:
a turbomachine having a compressor, a combustor, and a turbine in serial flow order;
a fan comprising fan blades, wherein in a forward mode of operation the fan blades have a forward pitch and generate forward thrust, and in a reverse mode of operation the fan blades have a reverse pitch and generate reverse thrust;
a fan drive shaft configured to drive the fan, wherein the turbomachine is configured to drive the fan drive shaft;
an electric machine connected to the fan drive shaft, wherein the electric machine is configured to, in the reverse mode of operation, operate as a motor to convert electric energy into rotation of the fan drive shaft; and
a controller that is configured to:
move the fan blades between the forward pitch and the reverse pitch in conjunction with the forward mode of operation and the reverse mode of operation;
control the electric machine to operate as the motor in the reverse mode of operation; and
wherein the turbomachine operates at a speed that is greater than zero and no faster than idle in the reverse mode of operation.
